(19) United States
(12) Patent Application Publication
(10) Pub. No.: US 2022/0300243 A1
(43) Pub. Date: Sep. 22, 2022

(54) SCREEN SHARING METHOD AND DEVICE AND ELECTRONIC EQUIPMENT

(71) Applicant: Beijing Bytedance Network Technology Co., Ltd., Beijing (CN)

(72) Inventors: Weijia DAI, Shanghai (CN); Shaohua YAN, Shanghai (CN); Pu CHENG, Shanghai (CN); Yin SHI, Shanghai (CN); Yali ZHANG, Shanghai (CN); Yanshen ZHANG, Shanghai (CN); Xiangxiang CHEN, Shanghai (CN)

(21) Appl. No.: 17/826,375

(22) Filed: May 27, 2022

Related U.S. Application Data
(63) Continuation of application No. PCT/CN2021/114330, filed on Aug. 24, 2021.

(30) Foreign Application Priority Data
Aug. 28, 2020 (CN) 202010888923.0

(51) Int. Cl. G06F 3/14; H04L 65/403; H04L 65/401

(52) U.S. Cl. CPC G06F 3/1454; H04L 65/403; H04L 65/4015

(57) ABSTRACT

A screen sharing method, a screen sharing apparatus and an electronic device are provided according to embodiments of the present disclosure. An embodiment of the method includes sending, in response to detecting a screen sharing operation after paired with a target display device for screen projection, shared screen data via a server to a target participant device in a multimedia conference, to trigger the target participant device to display a shared screen based on the shared screen data, where the target participant device includes the target display device. By the method, the screen sharing is realized by combining local screen projection and a multimedia conference.

### REFERENCE TO RELATED APPLICATION

This application is a continuation application of International Patent Application No. PCT/CN2021/114330, titled “SCREEN SHARING METHOD AND APPARATUS, AND ELECTRONIC DEVICE”, filed on Aug. 24, 2021, which claims priority to Chinese Patent Application No. 202010888923.0, titled “SCREEN SHARING METHOD AND APPARATUS, AND ELECTRONIC DEVICE”, filed on Aug. 28, 2020, both of which are incorporated herein by reference in their entireties.

### FIELD

The present disclosure relates to the technical field of computer, and in particular to a screen sharing method, a screen sharing apparatus and an electronic device.

### BACKGROUND

Nowadays, users can join multimedia conferences. In some scenarios, a user can join a multimedia conference by using a terminal device installed with a multimedia conference application. The multimedia conference application may be an application that provides a multimedia conference service.

In the related art, screen sharing can be achieved among different terminal devices joining the same multimedia conference.

### SUMMARY

This summary is provided to introduce the idea in a simplified form. The idea will be described in detail in the following description. This summary is neither intended to identify key features or essential features of the claimed technical solution, nor intended to be used to limit the scope of the claimed technical solution.

A screen sharing method, a screen sharing apparatus and an electronic device are provided according to embodiments of the present disclosure, which realize screen sharing by combining local screen projection and multimedia conference.

In a first aspect, a screen sharing method is provided according to embodiments of the present disclosure. The method includes: sending, in response to detecting a screen sharing operation after paired with a target display device for screen projection, shared screen data via a server to a target participant device in a multimedia conference, to trigger the target participant device to display a shared screen based on the shared screen data, where the target participant device includes the target display device.

In a second aspect, a screen sharing apparatus is provided according to embodiments of the present disclosure. The apparatus includes: a first sending unit, configured to send, in response to detecting a screen sharing operation after paired with a target display device for screen projection, shared screen data via a server to a target participant device in a multimedia conference, to trigger the target participant device to display a shared screen based on the shared screen data, where the target participant device includes the target display device.

In a third aspect, a screen sharing system is provided according to embodiments of the present disclosure. The system includes a terminal device, a server, and a target participant device. The terminal device is configured to send, in response to detecting a screen sharing operation after paired with a target display device for screen projection, shared screen data via the server to the target participant device in a multimedia conference, where the target participant device includes the target display device. The target participant device is configured to display the shared screen based on the shared screen data.

In a fourth aspect, an electronic device is provided according to embodiments of the present disclosure, including one or more processors, and a storage device storing one or more programs. The one or more programs, when executed by the one or more processors, cause the one or more processors to perform the method according to the first aspect.

In a fifth aspect, a computer-readable medium storing a computer program is provided according to embodiments of the present disclosure. The computer program, when executed by a processor, causes the processor to perform the method according to any one of claims 1 to 11.

With the screen sharing method, screen sharing apparatus and electronic device provided by the embodiments of the present disclosure, a screen sharing operation may be detected. Further, after paired with the target display device for screen projection, in response to a detected screen sharing operation, shared screen data is sent via a server to the target participant device of the multimedia conference. Then, the target participant device displays the shared screen based on the shared screen data. In practice, the target participant device includes the target display device. In this way, the screen sharing is realized by combining local screen projection and a multimedia conference. Therefore, the screen can be shared with not only the local target display device, but also the remote participant device.

### BRIEF DESCRIPTION OF THE DRAWINGS

The above and other features, advantages and aspects of various embodiments of the present disclosure will become more clear when taken in conjunction with the accompanying drawings and with reference to the following detailed description. Throughout the drawings, the same or similar reference numbers refer to the same or similar elements. It should be understood that the drawings are schematic and that the units and elements are not necessarily drawn to scale.

FIG. 1 is a flowchart of a screen sharing method according to an embodiment of the present disclosure;

FIG. 2 is a flowchart of initiating a multimedia conference in a screen sharing method according to an embodiment of the present disclosure;

FIG. 3 is a flowchart of joining a multimedia conference in a screen sharing method according to an embodiment of the present disclosure;

FIG. 4 is a flowchart of a screen sharing method according to another embodiment of the present disclosure;

FIG. 5 is a schematic structural diagram of a screen sharing apparatus according to an embodiment of the present disclosure;

FIG. 6 is a sequential chart of a screen sharing system according to an embodiment of the present disclosure;

FIG. 7 is a schematic architecture diagram of a system for applying a screen sharing method according to an embodiment of the present disclosure; and

FIG. 8 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be embodied in various forms and should not be construed as being limited to the embodiments set forth herein. The embodiments are provided for a more thorough and complete understanding. It should be understood that the drawings and embodiments of the present disclosure are only provided as examples, and are not intended to limit the protection scope of the present disclosure.

It should be understood that the various steps described in the method embodiments of the present disclosure may be performed in different orders and/or in parallel. Furthermore, method embodiments may include additional steps and/or omit an illustrated step. The scope of the present disclosure is not limited in this regard.

As used herein, the terms “including” and “comprising” and variations thereof are non-exclusive, i.e., meaning “including but not limited to”. The term “based on” means “at least partially based on”. The term “an embodiment” means “at least one embodiment”, the term “another embodiment” means “at least one another embodiment”, and the term “some embodiments” means “at least some embodiments”. Relevant definitions of other terms will be given in the description below.

It should be noted that concepts such as “first” and “second” mentioned in the present disclosure are only used to distinguish different devices, modules or units, and are not used to limit the order or interdependence of functions performed by these devices, modules or units.

It should be noted that the modifications of “a” and “a plurality” mentioned in the present disclosure are illustrative rather than restrictive, and those skilled in the art should understand that unless clearly indicated otherwise, they should be understood as “one or more”.

The names of messages or information exchanged between multiple devices in the embodiments of the present disclosure are only for illustrative purposes, and are not intended to limit the scope of these messages or information.

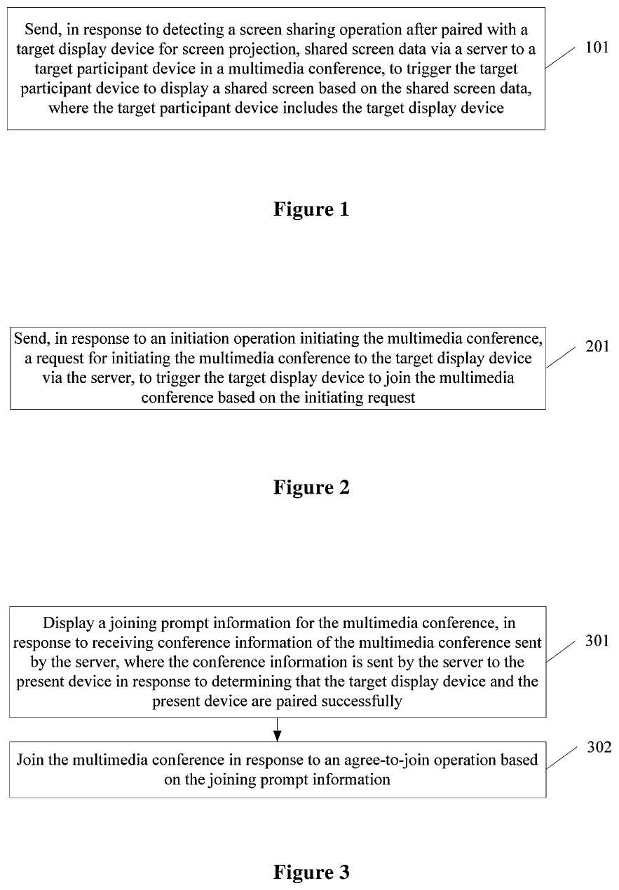

FIG. 1 is a flowchart of a screen sharing method according to an embodiment of the present disclosure. As shown in FIG. 1, the screen sharing method includes the following step 101.

In step 101, in response to detecting a screen sharing operation after paired with a target display device for screen projection, shared screen data is sent via a server to a target participant device in a multimedia conference, to trigger the target participant device to display a shared screen based on the shared screen data; where the target participant device includes the target display device.

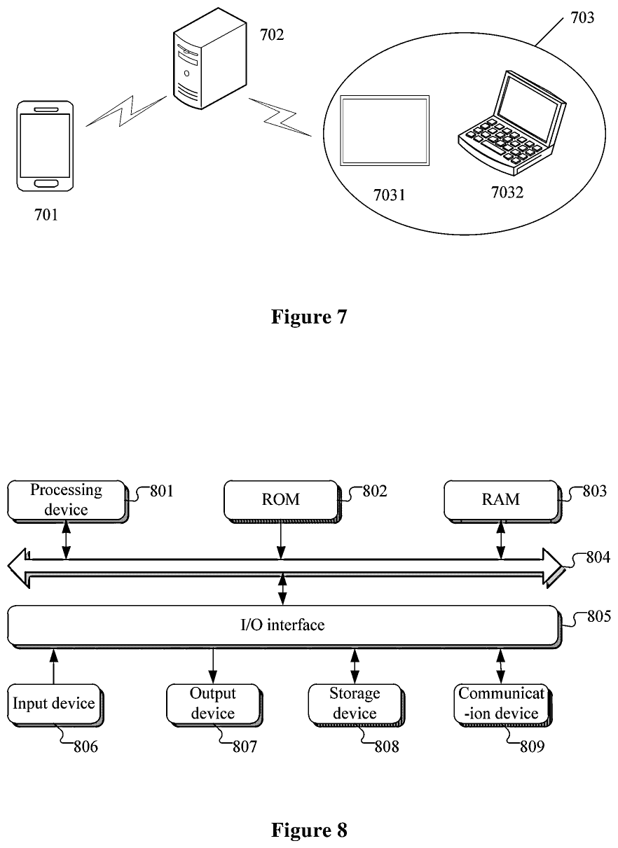

In this embodiment, a user can perform the screen sharing operation. After paired with the target display device for screen projection, the execution subject executing the screen sharing method (for example, the terminal device 701 shown in FIG. 7) detects the screen sharing operation.

The target display device may be a display device paired for screen projection with the execution subject. In practice, the pairing for screen projection may be a pairing for realizing local screen projection. In practice, the display device may be a device arranged in a conference room.

It is understood that the screen sharing operation may be any operation performed to share the screen with other devices. Here, the screen sharing operation can be understood as, for example, an operation initiated by a device to display the same content and/or interface as the device by a display screen of another display device and/or electronic device in a sharing range.

In some scenarios, the screen sharing operation may be a trigger operation performed by the user on a sharing control. Here, the shared control may be a control provided for sharing screen with other devices.

In some scenarios, the execution subject may detect, through a built-in detection program, the screen sharing operation.

In this embodiment, in response to the detected screen sharing operation, the execution subject may send the shared screen data to the target participant device of the multimedia conference via a server (for example, the server 702 shown in FIG. 7).

It is understood that the multimedia conference may be a multimedia conference that the executive subject participates in. That is, the executive subject may be a participant device of the multimedia conference. In practice, the multimedia conference may be an audio conference or a video conference.

The shared screen data may be data sent in order to share the screen with other devices.

The above target participant device may be a participant device that needs to receive the shared screen data. In some scenarios, the target participant device may be a participant device other than the execution subject.

The target participant device may include a target display device. It can be understood that the target display device may also be a participant device that needs to receive the shared screen data. It can also be understood that the multimedia conference may also be a conference attended by the target display device. That is, the target display device may also be a participant device of the multimedia conference.

As an example, the target participant device may include only the target display device (that is, the participating members of the multimedia conference only include the execution subject and the target display device). In this case, the execution subject may send the shared screen data to the target display device through the server, so that the target display device displays the shared screen. Thereby, the target display device paired for the local screen projection is used as a participating member of the multimedia conference, so as to share the screen with the execution subject.

As another example, the target participant device may include a target display device and another participant device (that is, the participating members of the multimedia conference include the execution subject, the target display device, and another participant device). In this case, the execution subject may send the shared screen data to the target display device and the other participant device via the server, so that the target display device and the other participant device can display the shared screen. Thereby, the target display device paired for the local screen projection and the other participant device remotely participating in the conference are used as conference members of the multimedia conference, so as to share the screen with the execution subject. Thereby, both the local screen sharing and the remote screen sharing can be achieved at the same time.

In some scenarios, in response to a detected screen sharing operation, the execution subject may send the shared screen data to the server. Further, in response to receiving the shared screen data, the server may send the shared screen data to the target participant device.

In this embodiment, in response to receiving the shared screen data, the target participant device may display the shared screen based on the shared screen data.

It is understood that the shared screen displayed by the target participant device may be the screen shared by the execution subject. Since the target participant device includes the target display device, after the execution subject is paired with the target display device for screen projection, the shared screen can be displayed on the target display device.

In the related art, in order to realize screen sharing, a user may join a multimedia conference by using a terminal device installed with a multimedia conference application. Screen sharing can be achieved among different terminal devices joining the same multimedia conference. In practice, the method of joining a multimedia conference through a terminal device installed with a multimedia conference application and sharing the screen in the multimedia conference may result in lower flexibility of screen sharing.

In this embodiment, after paired with the target display device for screen projection, a screen sharing operation is detected. Further, in response to the detected screen sharing operation, shared screen data is sent via a server to the target participant device of the multimedia conference. Further, the target participant device displays the shared screen based on the shared screen data. Therefore, it can be realized that the present device shares the screen with the target participant device of the multimedia conference. In practice, the target participant device may include the target display device. Therefore, the target display device displays the shared screen based on the received shared screen data. In this way, the present device can share the screen with the target display device in a manner of combining local screen projection and a multimedia conference.

By combining local screen projection and a multimedia conference, the screen can be shared with not only the local target display device, but also the remote participant device. Thereby, the flexibility of screen sharing can be improved.

In some embodiments, the multimedia conference is initiated by the present device (ie, the execution subject) to the target display device.

In some scenarios, after paired with the target display device for screen projection, the present device (ie, the execution subject) may initiate the multimedia conference to the target display device.

Thus, the present device actively initiates a multimedia conference to the target display device, so that the present device and the target display device join the same multimedia conference.

In some embodiments, the present device (that is, the execution subject) may initiate the multimedia conference to the target display device through the process shown in FIG. 2. The process includes the following step 201.

In step 201, in response to an initiation operation initiating the multimedia conference, a request for initiating the multimedia conference is sent to the target display device via the server, to trigger the target display device to join the multimedia conference based on the initiating request.

The initiation operation may be an operation of initiating the multimedia conference to the target display device. In some scenarios, the initiation operation may be a triggering operation performed by the user on an initiating control. In practice, the initiating control may be a control for initiating the multimedia conference to the target display device.

In some scenarios, in response to the initiation operation initiating the multimedia conference, the execution subject may send an initiation request to the server. The initiating request may be a request for initiating the multimedia conference to the target display device. Further, the server may send to the target display device the initiation request of the multimedia conference. Then, the target display device may join the multimedia conference based on the received initiation request.

In some scenarios, in response to receiving the initiation request, the target display device may directly join the multimedia conference.

In other scenarios, the target display device may join the multimedia conference in a manner by which a to-be-participant device join the multimedia conference, which will be described later.

Thus, by initiating a multimedia conference to the target display device, the execution subject and the target display device can join the same multimedia conference. Further, after paired with the target display device for screen projection, the shared screen data may be sent to the target participant device via the server, so as to share screen with the target participant device.

In some embodiments, the present device (that is, the execution subject) may be paired for screen projection with the target display in the following manner.

In a first step, pairing information determined from a received near-field communication signal is displayed.

The near-field communication signal may be a signal broadcast by a display device. Optionally, the near-field communication signal may include at least one of the following: an ultrasonic signal, a Bluetooth signal, a wireless local area network signal, and the like.

In practice, the pairing information is carried in the near-field communication signal broadcast by the display device. The pairing information is used to pair a device with a display device for screen projection. Optionally, the pairing information may be a pairing code.

In some scenarios, in response to receiving the near-field communication signal broadcast by the display device, the execution subject may determine the pairing information carried in the near-field communication signal. Further, the execution subject may display the determined pairing information.

In practice, the above execution subject may receive a near-field communication signal broadcast by at least one display device.

In a second step, in response to a pairing operation associated with the pairing information corresponding to the target display device, pairing for screen projection with the target display device is performed.

The pairing operation may be an operation to realize the pairing of the execution subject with the target display device. In some scenarios, the pairing operation may be a triggering operation performed by the user on a pairing control.

The pairing information corresponding to the target display device may be pairing information carried in the near-field communication signal broadcast by the target display device.

The display device may broadcast a near-field communication signal carrying pairing information. Further, the execution subject may determine the pairing information from the near-field communication signal broadcast by the display device, and display the pairing information. Then, if the user performs a pairing operation associated with pairing information corresponding to the target display device, the pairing for screen projection between the execution subject and the target display device is performed.

In some embodiments, the target display device joins the multimedia conference earlier than the present device.

The present device (that is, the execution subject) can join the multimedia conference through the process shown in FIG. 3, which includes steps 301 and 302 described below.

In step 301, in response to receiving conference information of the multimedia conference sent by the server, joining prompt information for the multimedia conference is displayed, where the conference information is sent by the server to the present device in response to determining that the target display device and the present device are paired successfully.

The conference information may be information describing the multimedia conference. In practice, the above conference information may include at least one of: a conference name, user information of the initiating user, number of participants, and the like.

In practice, in response to determining that the target display device and the execution subject are successfully paired for screen projection, the server may send the conference information of the multimedia conference to the execution subject.

In some scenarios, after successfully pairing with the target display device for screen projection, the execution subject may send pairing result information to the server to indicate that the pairing is successful. Further, the server may determine, according to the pairing result information, that the target display device and the execution subject are successfully paired for screen projection.

The joining prompt information may be information used to prompt the user to join the multimedia conference.

In step 302, the present device joins the multimedia conference in response to an agree-to-join operation based on the joining prompt information.

The agree-to-join operation may be an operation to realize that the execution subject joins the multimedia conference.

In some scenarios, the joining prompt information may include an agree-to-join control. Here, the agree-to-join control may be used to indicate agreeing to join the multimedia conference. A user can perform a triggering operation on the agree-to-join control. In response to the triggering operation on the agree-to-join control, the execution subject may join the multimedia conference. It is understood that the agree-to-join operation may be the triggering operation on the agree-to-join control.

Therefore, if the target display device joins the multimedia conference in advance, the present device may send the shared screen data to the target participant device of the multimedia conference via the server after joining the multimedia conference. Further, the target participant device may display the shared screen of the execution subject based on the received shared screen data. Therefore, after joining the multimedia conference that the target display device joins in advance, the present device can share the screen with the target participant device.

In some embodiments, the target participant device displays an input control for inputting call information based on the display of the shared screen. The call information is used to call a to-be-participant device to join the multimedia conference.

In some scenarios, in response to displaying the shared screen, the target participant device may display an input control.

In practice, the user of the target participant device can input call information in the input control.

In Some Scenarios, According to the Call Information, the Shared Screen of the Execution Subject May be Shared with the to-be-Participant Device.

Specifically, in response to receiving the call information, the target participant device may send, via the server, a call request to the to-be-participant device indicated by the call information. Further, the to-be-participant device may join the multimedia conference based on the received call request. Then, in response to determining that the to-be-participant device already joins the multimedia conference, the server may send the shared screen data to the to-be-participant device. Thus, the to-be-participant device can display the shared screen of the execution subject based on the received shared screen data.

For details of sharing the screen of the execution subject with the to-be-participant device, reference may be made to the method described in step 302 of the embodiment shown in FIG. 3, which will not be repeated here.

In some embodiments, the target participant device includes at least one of: a display device other than the target display device, and a terminal device that uses a multimedia conference application to join the multimedia conference.

The multimedia conference application may be an application that provides the multimedia conference.

In this way, the target participant device displays the shared screen, so that the screen can be shared with a display device other than the target display device. Thus, the present device can share the screen with a display device arranged in another conference room. In addition, the present device can share the screen with the terminal device that uses the multimedia conference application to join the multimedia conference.

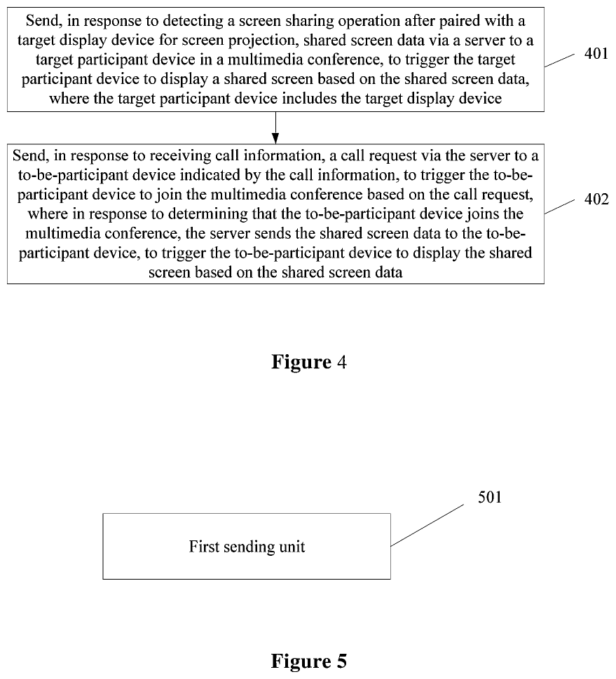

Reference is made to FIG. 4, which is a flowchart of a screen sharing method according to another embodiment of the present disclosure. As shown in FIG. 4, the screen sharing method includes the following steps 401 and 402.

In step 401, in response to detecting a screen sharing operation after paired with a target display device for screen projection, shared screen data is sent via a server to a target participant device in a multimedia conference, to trigger the target participant device to display a shared screen based on the shared screen data. The target participant device includes the target display device.

For details of step 401, reference may be made to step 101 of the embodiment shown in FIG. 1, which is not repeated here.

In step 402, in response to receiving call information, a call request via the server to a to-be-participant device indicated by the call information, to trigger the to-be-participant device to join the multimedia conference based on the call request, where in response to determining that the to-be-participant device already joins the multimedia conference, the server sends the shared screen data to the to-be-participant device, to trigger the to-be-participant device to display the shared screen based on the shared screen data.

In this embodiment, the execution subject of the screen sharing method (for example, the terminal device 701 shown in FIG. 7) may receive the call information.

The above call information is used to call the to-be-participant device to join the above multimedia conference.

In some scenarios, the execution subject may receive the call information inputted by means of voice.

In this embodiment, in response to receiving the call information, the execution subject may send, via a server (for example, the server 702 shown in FIG. 7), a call request to the to-be-participant device indicated by the call information.

The call request may be a request for calling the to-be-participant device to join the multimedia conference.

In some scenarios, in response to receiving the call information, the execution subject may send the call information to the server. Further, the server may send the call request to the to-be-participant device indicated by the call information.

In this embodiment, the to-be-participant device may join the multimedia conference based on the received call request.

In some scenarios, in response to receiving the call request, the to-be-participant device may directly join the multimedia conference.

In this embodiment, in response to determining that the to-be-participant device already joins the multimedia conference, the server may send the shared screen data to the to-be-participant device.

In some scenarios, after the to-be-participant device already joins the multimedia conference, it may send information indicating that it already joins the multimedia conference to the server. Thus, the server can determine that the to-be-participant device already joins the multimedia conference according to the information.

In this embodiment, the to-be-participant device may display the shared screen based on the shared screen data sent by the server.

As an example, the target participant device includes only the target display device (that is, the participating members of the multimedia conference only include the execution subject and the target display device). In this case, according to the call information, more devices can be invited to participate in the multimedia conference. In this way, a small local conference can be changed to a large online conference.

In this embodiment, in response to receiving the call information, a call request is sent via the server to the to-be-participant device indicated by the call information. Further, the to-be-participant device joins the multimedia conference based on the call request. Then, in response to determining that the to-be-participant device already joins the multimedia conference, the server sends the shared screen data to the to-be-participant device. Finally, the to-be-participant device displays the shared screen based on the shared screen data. Therefore, more devices can be called to participate in the multimedia conference, and the screen can be shared with the devices that join the multimedia conference. As a result, the scope of screen sharing is extended.

In some embodiments, the call information is inputted by the user in the displayed input control.

The input control may be a control for inputting call information.

Therefore, after the execution subject displays the input control, the user may input call information through the input control.

In some embodiments, the call information includes at least one of: device calling information of the to-be-participant device, and contact calling information of a contact person of the to-be-participant device.

The device calling information may be information used to call the to-be-participant device. For example, the device calling information may be the calling number of the to-be-participant device.

The contact calling information may be information used to call the contact person of the to-be-participant device. For example, the contact calling information may be a phone number or an email address of the contact person.

Correspondingly, the input control includes at least one of: an input control for the contact calling information, and an input control for the device calling information.

In the following, the input control for the contact calling information is referred to as a first input control, and the input control for the device calling information is referred to as a second input control.

In this case, the user may input the contact calling information in the first input control, and may input the device calling information in the second input control.

In some embodiments, the to-be-participant device may join the multimedia conference by performing the following steps.

In a first step, a call interface is displayed in response to receiving a call request.

The call interface includes an agree-to-join control for agreeing to join the multimedia conference.

In a second step, in response to a triggering operation on the agree-to-join control, the to-be-participant device joins the multimedia conference.

Therefore, if the user of the to-be-participant device performs a triggering operation on the agree-to-join control, the to-be-participant device can join the multimedia conference.

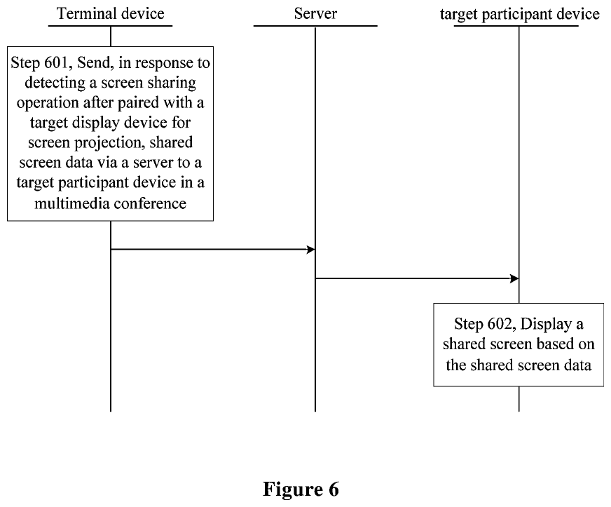

Referring to FIG. 5, to implement the above methods, a screen sharing apparatus is provided according to an embodiment of the present disclosure. The apparatus embodiment corresponds to the method embodiment as shown in FIG. 1, and may be applied in various electronic devices.

As shown in FIG. 5, the screen sharing apparatus in this embodiment includes: a first sending unit 501. The first sending unit 501 is configured to send, in response to detecting a screen sharing operation after paired with a target display device for screen projection, shared screen data via a server to a target participant device in a multimedia conference, to trigger the target participant device to display a shared screen based on the shared screen data, where the target participant device includes the target display device.

In this embodiment, for details of the processing of the first sending unit 501 of the screen sharing device and the technical effect thereof, one may refer to the description of step 101 in the embodiment as shown FIG. 1, which are not repeated here.

In some embodiments, the screen sharing apparatus may further include a second sending unit (not shown in the figure). The second sending unit is configured to send, in response to receiving call information, a call request via the server to a to-be-participant device indicated by the call information, to trigger the to-be-participant device to join the multimedia conference based on the call request. In response to determining that the to-be-participant device already joins the multimedia conference, the server sends the shared screen data to the to-be-participant device, to trigger the to-be-participant device to display the shared screen based on the shared screen data.

In some embodiments, the call information is inputted through a displayed input control.

In some embodiments, the call information includes at least one of: device calling information of the to-be-participant device, and contact calling information of a contact person of the to-be-participant device. The input controls includes at least one of: an input control for the contact calling information, and an input control for the device calling information.

In some embodiments, the to-be-participant device joins the multimedia conference by: displaying a call interface in response to receiving the call request, where the call interface includes an agree-to-join control for agreeing to join the multimedia conference; and joining the multimedia conference in response to a triggering operation on the agree-to-join control.

In some embodiments, the multimedia conference is initiated by a present device to the target display device.

In some embodiments, the screen sharing apparatus may further include an initiating unit (not shown in the figure). The initiating unit is configured to send, in response to an initiation operation initiating the multimedia conference, a request for initiating the multimedia conference to the target display device via the server, to trigger the target display device to join the multimedia conference based on the initiating request.

In some embodiments, the screen sharing apparatus may further include a pairing unit (not shown in the figure). The pairing unit is configured to: display pairing information determined from a received near-field communication signal, where the near-field communication signal is broadcast by a display device, and pair with the target display device for screen projection, in response to a pairing operation associated with the pairing information corresponding to the target display device.

In some embodiments, the target display device joins the multimedia conference earlier than the present device. The screen sharing apparatus may further include a joining unit (not shown in the figure). The joining unit is configured to: display joining prompt information for the multimedia conference, in response to receiving conference information of the multimedia conference sent by the server, where the conference information is sent by the server to the present device in response to determining that the target display device and the present device are successfully paired for screen projection; and join the multimedia conference in response to an agree-to-join operation based on the joining prompt information.

In some embodiments, the target participant device displays, based on display of the shared screen, an input control for inputting call information, where the call information is used to call a to-be-participant device to join the multimedia conference.

In some embodiments, the target participant device includes at least one of: a display device other than the target display device, and a terminal device that joins the multimedia conference by using a multimedia conference application.

FIG. 6 is a sequential chart of a screen sharing system according to an embodiment of the present disclosure. The screen sharing system includes a terminal device, a server and a target participant device. The interaction process between the terminal device, the server and the target participant device includes step 601 and step 602 as shown in FIG. 6.

In this embodiment, the target participant device may be a participant device of the multimedia conference in which the terminal device participates. The target participant device includes a target display device. It can be seen that the terminal device and the target display device may participate in the same multimedia conference.

In step 601, after the terminal device is paired with the target display device for screen projection, in response to detecting a screen sharing operation, the terminal device sends, via the server, shared screen data to the target participant device of the multimedia conference in which the terminal device participates.

Specifically, the terminal device may detect the screen sharing operation. After paired with the target display device for screen projection, in response to the detected screen sharing operation, the terminal device may send the shared screen data to the target participant device via the server.

In step 602, the target participant device displays the shared screen based on the shared screen data.

In this embodiment, the terminal device sends the shared screen data to the target participant device via the server, and the target participant device displays the shared screen of the terminal device based on the received shared screen data. Therefore, the terminal device can share the screen with the target participant device of the multimedia conference. In practice, the target participant device includes the target display device. Therefore, after paired with the target display device for screen projection, the target display device displays the shared screen of the terminal device based on the shared screen data. Therefore, the terminal device shares the screen with the target display device by way of screen projection.

In some embodiments, the terminal device, in response to receiving the call information, sends a call request via the server to the to-be-participant device indicated by the call information, so that the to-be-participant device joins the multimedia conference based on the call request. The server, in response to determining that the to-be-participant device already joins the multimedia conference, sends the shared screen data to the to-be-participant device, so that the to-be-participant device displays the shared screen based on the shared screen data.

Specifically, in response to receiving the call information, the terminal device may send a call request to the to-be-participant device indicated by the call information via the server. Further, the to-be-participant device may join the multimedia conference based on the received call request. Then, in response to determining that the to-be-participant device already joins the multimedia conference, the server may send the shared screen data of the terminal device to the to-be-participant device. Thus, the to-be-participant device can display the shared screen of the terminal device based on the received shared screen data.

In some embodiments, the multimedia conference is initiated by the terminal device to the target display device. The terminal device, in response to an initiation operation for initiating a multimedia conference, sends a request for initiating the multimedia conference to the target display device via the server. The target display device joins the multimedia conference based on the initiating request.

Specifically, in response to the initiation operation initiating the multimedia conference, the terminal device may send the request for initiating the multimedia conference to the target display device via the server. Further, the target display device may join the multimedia conference based on the received initiation request.

In some embodiments, the target display device joins the multimedia conference earlier than the terminal device. The server sends conference information of the multimedia conference to the terminal device in response to determining that the target display device is successfully paired with the terminal device for screen projection. The terminal device, in response to receiving the conference information, displays joining prompt information for the multimedia conference, and joins the multimedia conference in response to an agree-to-join operation based on the joining prompt information.

Specifically, in response to determining that the target display device is successfully paired with the terminal device for screen projection, the server may send the conference information of the multimedia conference to the terminal device. Further, in response to receiving the conference information, the terminal device may display the joining prompt information for the multimedia conference. Then, in response to the agree-to-join operation based on the joining prompt information, the terminal device joins the multimedia conference.

It should be noted that the interaction methods and the technical effects of the screen sharing system are all described in the embodiments of the screen sharing method, and will not be repeated here.

FIG. 7 is a schematic architecture diagram of a system for applying a screen sharing method according to an embodiment of the present disclosure.

As shown in FIG. 7, the system may include a terminal device 701, a server 702, and a target participant device 703. The target participant device 703 may include a target display device 7031 and a terminal device 7032. The terminal device 701, the server 702 and the target participant device 703 communicate through a network. In practice, the network may be in various connections, such as wired or wireless communication links or fiber optic cables.

The terminal device 701 may interact with the target participant device 703 through the server 702. Various client applications may be installed on the terminal device 701. For example, the terminal device 701 may be installed with a multimedia conference application providing a multimedia conference service, a screen projection application providing a screen projection function, and the like.

In some scenarios, after paired with the target display device 7031 for screen projection, the terminal device 701 may send, in response to detecting a screen sharing operation, screen sharing data to the target participant device 703 via the server 702. Further, the target participant device 703 may display the shared screen of the terminal device 701 based on the received screen sharing data.

The terminal device 701 and the terminal device 7032 may be embodied in hardware or software. When the terminal device 701 and the terminal device 7032 are embodied in hardware, they may be various electronic devices having display screens and supporting information interaction functions, including but not limited to smart phones, tablet computers, laptop computers, and desktop computers. When the terminal device 701 and the terminal device 7032 are embodied in software, they may be installed in the electronic devices listed above, and can be implemented as multiple software or software modules, or a single software or software module, which is not limited herein.

The target display device 7031 may be embodied in hardware or software. When the target display device 7031 is embodied in hardware, it may be various electronic devices having display screens and supporting screen projection functions. For example, the target display device 7031 may be a display device arranged in a conference room. When the target display device 7031 is embodied in software, it may be installed in the above electronic devices. The target display device 7031 may be implemented as multiple software or software modules, or a single software or software module, which is not limited herein.

The server 702 may be a server that provides various services. In some scenarios, the server 702 may send the shared screen data of the terminal device 701 to the target participant device 703.

The server 702 may be embodied in hardware or software. When the server 702 is embodied in hardware, it may be implemented as a distributed server cluster composed of multiple servers, or may be implemented as a single server. When the server 702 is embodied in software, it may be implemented as multiple software or software modules (for example, multiple software or software modules for providing distributed services), or may be implemented as a single software or software module, which is not limited herein.

It is noted that the screen sharing method provided by the embodiments of the present disclosure may be executed by the terminal device 701, and the screen sharing apparatus may be arranged in the terminal device 701.

It should be understood that the numbers of terminal devices, servers and target participant devices in FIG. 7 are only illustrative. There may be any number of terminal devices, servers and target participant devices according to the implementation requirements.

FIG. 8 shows a schematic structural diagram of an electronic device (such as the terminal device shown in FIG. 7) suitable for implementing the embodiments of the present disclosure. Terminal devices in the embodiments of the present disclosure may include, but are not limited to, mobile terminals, such as mobile phones, notebook computers, digital broadcast receivers, PDAs (Personal Digital Assistants), PADs (Tablet computers), PMPs (Portable Multimedia Players), vehicle-mounted terminals (such as in-vehicle navigation terminals), and the like, and fixed terminals such as digital TVs, desktop computers, and the like. The electronic device shown in FIG. 8 is only an example, and should not impose any limitation on the functions and applications of the embodiments of the present disclosure.

As shown in FIG. 8, the electronic device may include a processing device (such as a central processing unit, a graphics processor) 801 that may execute various appropriate actions and processes according to a program stored in a read only memory (ROM) 802 or loaded into random access memory (RAM) 803 from a storage device 808. In the RAM 803, various programs and data necessary for the operation of the electronic device are also stored. The processing device 801, the ROM 802, and the RAM 803 are connected to each other through a bus 804. An input/output (I/O) interface 805 is also connected to the bus 804.

Normally, the following devices may be connected to the I/O interface 805: an input device 806 such as a touch screen, a touchpad, a keyboard, a mouse, a camera, a microphone, an accelerometer, a gyroscope and the like; an output device 807, such as a liquid crystal display (LCD), a speaker, a vibrator and the like; a storage device 808, such as a magnetic tape, a hard disk and the like; and a communication device 809. The communication device 809 may enable the electronic device to communicate in a wireless or wired manner with other devices to exchange data. Although FIG. 8 shows the electronic device having various means, it should be understood that not all of the illustrated means are required to be implemented or provided. More or fewer devices may alternatively be implemented or provided. Each block shown in FIG. 8 may represent one device or multiple devices as required.

In particular, according to embodiments of the present disclosure, the processes described above with reference to the flowcharts may be implemented as computer software programs. For example, embodiments of the present disclosure include a computer program product including a computer program carried on a non-transitory computer readable medium. The computer program includes program code for performing the method illustrated in the flowchart. In such an embodiment, the computer program may be downloaded and installed from the network via the communication device 809, or from the storage device 808, or from the ROM 802. When the computer program is executed by the processing device 801, the functions in the methods of the embodiments of the present disclosure are executed.

It should be noted that the computer-readable medium mentioned above in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of computer readable storage media may include, but are not limited to, electrical connections with one or more wires, portable computer disks, hard disks, a random access memory (RAM), a read only memory (ROM), an erasable Programmable read only memory (EPROM or flash memory), a optical fiber, a portable compact disk read only memory (CD-ROM), optical storage devices, magnetic storage devices, or any suitable combination thereof. In this disclosure, a computer-readable storage medium may be any tangible medium that contains or stores a program that can be used by or in conjunction with an instruction execution system, apparatus or device. In the present disclosure, a computer-readable signal medium may include a data signal propagated in baseband or as part of a carrier wave with computer-readable program code embodied thereon. Such propagated data signals may be in a variety of forms, including but not limited to electromagnetic signals, optical signals, or any suitable combination thereof. A computer-readable signal medium can also be any computer-readable medium other than a computer-readable storage medium that can transmit, propagate, or transport the program for use by or in connection with the instruction execution system, apparatus or device. Program code stored on a computer readable medium may be transmitted using any suitable medium including, but not limited to, an electrical wire, an optical fiber cable, RF (radio frequency), or any suitable combination thereof.

In some embodiments, the client and server may use any currently known or future network protocol such as HTTP (HyperText Transfer Protocol) to communicate, and may be connected with digital data network in any form or medium (such as a communication network). Examples of communication networks include local area networks (LAN), wide area networks (WAN), the Internet (eg, the Internet), and peer-to-peer networks (such as ad hoc peer-to-peer networks), as well as any current or future network.

The computer-readable medium may be included in the multimedia conference device, or may exist alone without being assembled into the multimedia conference device. The computer-readable medium carries one or more programs. The one or more programs, when being executed by the multimedia conference device, cause the multimedia conference device to send, in response to detecting a screen sharing operation after paired with a target display device for screen projection, shared screen data via a server to a target participant device in a multimedia conference, to trigger the target participant device to display a shared screen based on the shared screen data, where the target participant device includes the target display device.

Computer program code for performing operations of the present disclosure may be written in one or more programming languages, including but not limited to object-oriented programming languages, such as Java, Smalltalk, C++, and conventional procedural programming languages, such as the “C” language or similar programming languages. The program code may be executed entirely on a user computer, or partly on a user computer, or as a stand-alone software package, or partly on a user computer and partly on a remote computer, or entirely on a remote computer or server. In the case of using a remote computer, the remote computer may be connected to the user's computer through any kind of network, including a local area network (LAN) or a wide area network (WAN), or may be connected to an external computer (eg, using Internet connection provided by an Internet service provider).

The flowcharts and block diagrams in the Figures illustrate the architecture, functionality, and operations of possible implementations of systems, methods and computer program products according to various embodiments of the present disclosure. In this regard, each block in the flowcharts or block diagrams may represent a module, program segment, or a portion of code that contains one or more executable instructions for implementing the specified logical functions. It should also be noted that, in some alternative implementations, the functions noted in the blocks may occur in an order other than the order shown in the figures. For example, two blocks shown in succession may be executed substantially concurrently, or the blocks may sometimes be executed in the reverse order, depending upon the functionality involved. It is also noted that each block of the block diagrams and/or flowchart illustrations, and combinations of blocks in the block diagrams and/or flowchart illustrations, may be implemented in dedicated hardware-based systems that perform the specified functions or operations, or may be implemented by a combination of dedicated hardware and computer instructions.

The units involved in the embodiments of the present disclosure may be implemented in a software manner, or in a hardware manner. The name of the unit does not constitute a limitation of the unit under any circumstances. For example, the first sending unit may be described as a unit that sends, in response to detecting a screen sharing operation after paired with a target display device for screen projection, shared screen data via a server to a target participant device in a multimedia conference.

The functions described above may be performed, at least in part, by one or more hardware logic components. For example, without limitation, examples of hardware logic components that may be used include: a Field Programmable Gate Array (FPGA), a Application Specific Integrated Circuit (ASIC), an Application Specific Standard Product (ASSP), a System on Chip (SOC), a Complex Programmable Logical Device (CPLD) and the like.

In the present disclosure, a machine-readable medium may be a tangible medium that may contain or store a program for use by or in connection with the instruction execution system, apparatus or device. The machine-readable medium may be a machine-readable signal medium or a machine-readable storage medium. Machine-readable media may include, but are not limited to, electronic, magnetic, optical, electromagnetic, infrared, or semiconductor systems, devices, or devices, or any suitable combination thereof. More specific examples of machine-readable storage media include one or more wire-based electrical connections, portable computer disks, hard disks, random access memory (RAM), read only memory (ROM), erasable programmable read only memory (EPROM or flash memory), fiber optics, compact disk read only memory (CD-ROM), optical storage devices, magnetic storage devices, or any suitable combination thereof.

The above merely describes preferred embodiments of the present disclosure and illustrates the technical principles. Those skilled in the art should understand that the scope of the disclosure is not limited to the technical solutions formed by the specific combination of the technical features, and should also cover, without departing from the above disclosed concept, the technical solutions formed by any combination of the technical features or other equivalent features. For example, a technical solution may be formed by replacing a feature with another feature having similar function disclosed in the present disclosure (but not limited to).

Additionally, although operations are illustrated in a particular order, this should not be construed as requiring the operations to be performed in the particular shown order. Under certain circumstances, multitasking and parallel processing may be advantageous. Similarly, although the above discussion contains several specific details, these should not be construed as limitations on the scope of the present disclosure. Certain features that are described in the context of separate embodiments can also be combined into a same embodiment. Conversely, various features that are described in the context of a same embodiment can also be implemented in multiple embodiments separately or in any suitable subcombination.

Although the subject matter has been described in language specific to structural features and/or logical method steps, it is to be understood that the subject matter defined in the appended claims is not necessarily limited to the specific features or steps described above. Rather, the specific features and steps described above are merely examples of implementing the claims.

1. A screen sharing method, comprising:
sending, in response to detecting a screen sharing operation after paired with a target display device for screen projection, shared screen data via a server to a target participant device in a multimedia conference, to trigger the target participant device to display a shared screen based on the shared screen data, wherein the target participant device comprises the target display device.

2. The method according to claim 1, further comprising:
sending, in response to receiving call information, a call request via the server to a to-be-participant device indicated by the call information, to trigger the to-be-participant device to join the multimedia conference based on the call request,
wherein in response to determining that the to-be-participant device already joins the multimedia conference, the server sends the shared screen data to the to-be-participant device, to trigger the to-be-participant device to display the shared screen based on the shared screen data.

3. The method according to claim 2, wherein the call information is inputted through a displayed input control.

4. The method according to claim 3, wherein
the call information comprises at least one of: device calling information of the to-be-participant device, and contact calling information of a contact person of the to-be-participant device; and
the input control comprises at least one of: an input control for the contact calling information, and an input control for the device calling information.

5. The method according to claim 2, wherein the to-be-participant device joins the multimedia conference by:
displaying a call interface in response to receiving the call request, wherein the call interface includes an agree-to-join control for agreeing to join the multimedia conference; and
joining the multimedia conference in response to a triggering operation on the agree-to-join control.

6. The method according to claim 1, wherein the multimedia conference is initiated to the target display device by a present device that performs the method.

7. The method according to claim 6, wherein the present device initiates the multimedia conference to the target display device by:
sending, in response to an initiation operation initiating the multimedia conference, a request for initiating the multimedia conference to the target display device via the server, to trigger the target display device to join the multimedia conference based on the initiating request.

8. The method according to claim 1, wherein a present device that performs the method is paired with the target display device for screen projection by:
displaying pairing information determined from a received near-field communication signal, wherein the near-field communication signal is broadcast by a display device, and the pairing information is used for pairing with a display device for screen projection; and
pairing with the target display device for screen projection, in response to a pairing operation associated with the pairing information corresponding to the target display device.

9. The method according to claim 1, wherein the target display device joins the multimedia conference earlier than a present device that performs the method; and
the present device joins the multimedia conference by:
displaying joining prompt information for the multimedia conference in response to receiving conference information of the multimedia conference sent by the server, wherein the conference information is sent by the server to the present device in response to determining that the target display device and the present device are successfully paired for screen projection; and
joining the multimedia conference in response to an agree-to-join operation based on the joining prompt information.

10. The method according to claim 1, wherein the target participant device displays, based on display of the shared screen, an input control for inputting call information, wherein the call information is used to call a to-be-participant device to join the multimedia conference.

11. The method according to claim 1, wherein the target participant device comprises at least one of:
a display device other than the target display device; and
a terminal device that joins the multimedia conference by using a multimedia conference application.

12. A screen sharing apparatus, comprising:
one or more processors; and
a storage device storing one or more programs,
wherein the one or more programs, when executed by the one or more processors, cause the one or more processors to perform operation comprising:
sending, in response to detecting a screen sharing operation after paired with a target display device for screen projection, shared screen data via a server to a target participant device in a multimedia conference, to trigger the target participant device to display a shared screen based on the shared screen data, wherein the target participant device comprises the target display device.

13. A screen sharing system, comprising:
a terminal device,
a server, and
a target participant device,
wherein the terminal device is configured to send, in response to detecting a screen sharing operation after paired with a target display device for screen projection, shared screen data via the server to the target participant device in a multimedia conference, wherein the target participant device comprises the target display device; and
wherein the target participant device is configured to display the shared screen based on the shared screen data.

14. The system according to claim 13, wherein
the terminal device is configured to send, in response to receiving call information, a call request via the server to a to-be-participant device indicated by the call information, to trigger the to-be-participant device to join the multimedia conference based on the call request; and
the server is configured to send, in response to determining that the to-be-participant device already joins the multimedia conference, the shared screen data to the to-be-participant device, to trigger the to-be-participant device to display the shared screen based on the shared screen data.

15. The system according to claim 13, wherein the multimedia conference is initiated by the terminal device to the target display device;
the terminal device is configured to send, in response to an initiation operation for initiating the multimedia conference, a request for initiating the multimedia conference to the target display device via the server; and
the target display device is configured to join the multimedia conference based on the initiation request.

16. The system according to claim 13, wherein the target display device joins the multimedia conference earlier than the terminal device;
the server is configured to send conference information of the multimedia conference to the terminal device in response to determining that the target display device and the terminal device are successfully paired for screen projection; and
the terminal device is configured to display joining prompt information for the multimedia conference in response to receiving the conference information, and join the multimedia conference in response to an agree-to-join operation based on the joining prompt information.

17. A computer-readable medium storing a computer program, wherein the computer program, when executed by a processor, causes the processor to perform the method according to claim 1.

18. The apparatus according to claim 12, wherein the one or more programs, when executed by the one or more processors, cause the one or more processors to perform operation comprising:
sending, in response to receiving call information, a call request via the server to a to-be-participant device indicated by the call information, to trigger the to-be-participant device to join the multimedia conference based on the call request,
wherein in response to determining that the to-be-participant device already joins the multimedia conference, the server sends the shared screen data to the to-be-participant device, to trigger the to-be-participant device to display the shared screen based on the shared screen data.

19. The apparatus according to claim 18, wherein the call information is inputted through a displayed input control.

20. The apparatus according to claim 19, wherein
the call information comprises at least one of: device calling information of the to-be-participant device, and contact calling information of a contact person of the to-be-participant device; and
the input control comprises at least one of: an input control for the contact calling information, and an input control for the device calling information.
